(19) United States
(12) Patent Application Publication
(10) Pub. No.: US 2008/0293571 A1
(43) Pub. Date: Nov. 27, 2008

(54) Insecticide organic fertilizer composition, process and method

(76) Inventor: William Dean Holz, Round Rock, TX (US)

Correspondence Address: ERNEST D. BUFF;ERNEST D. BUFF AND ASSOCIATES, LLC., 231 SOMERVILLE ROAD, BEDMINSTER, NJ, 07921, US

(21) Appl. No.: 11/807,262

(22) Filed: May 25, 2007

(51) Int. Cl. C05F 3/00; A01N 65/00; A01P 7/04

(52) U.S. Cl. 504/102; 424/761; 504/101; 514/65

(57) ABSTRACT

An insecticide organic fertilizer composition eradicates insects such as imported fire ants (IFA). The insecticide organic fertilizer composition comprises an aqueous homogenized manure extract having an active ingredient, a surfactant, a solvent, and a fatty acid. Active ingredients include botanical insecticides which are subject to degradation after a preselected period of time upon delivery to a soil area. The botanical insecticide is selected from the group consisting of rotenone, pyrethrum, sabadilla (varatrine), neem (azadirachtin), ryania (ryanodine), and mixtures thereof, with rotenone being the preferable botanical insecticide selected. Advantageously, the combination of these components and component amounts renders the botanical insecticide's active ingredients, including rotenone, stable in the aqueous organic manure extract for a predetermined period of time. During this predetermined period of time, the insecticide organic fertilizer composition biologically interferes with IFA's pheromone distress signals. Upon application of the insecticide organic fertilizer composition to an IFA mound, the IFAs began to exhibit a state of sluggishness and gradually begin to die over time rather than relocating, effectuating effective eradication after treatment. In addition, the biotanical insecticide functions to fertilize and nourish soil near the vicinity of the mound.

### BACKGROUND OF THE INVENTION

1. Field of the Invention

The present invention relates to an insecticide organic fertilizer composition, process and method for eradicating insects; and more particularly to an insecticide organic fertilizer composition that provides an environmentally friendly means of eradicating or controlling the spread of fire ants using a botanical insecticide mixed with homogenized manure and a surfactant.

2. Description of the Prior Art

Fire ant colonies typically nest in soil near moist areas, such as river banks, pond edges and watered lawns, and produce large mounds having several small openings on the surface or in cracks. The species Solenopsis invicta, commonly known as the red imported fire ant (IFA), has invaded portions of the United States. In the absence of the IFA's predators and parasites, it has become a major pest nearly everywhere it has been introduced, infesting large parts of the southern states, becoming well established in more than thirteen states. In areas such as Texas, Arkansas and parts of Oklahoma, they are one of the predominant pests invading homes, wildlife, livestock and farms.

Attempts to eradicate IFAs have included natural means, such as introduction of fly predators, and chemical means, including ground baiting and pesticide application. However, these attempts have failed to provide an effective, environmentally sound method of eradicating the IFA colonies. Implementation of large-scale programs has been introduced in several states to control the IFA infestation. For example, in Texas a Texas Two-Step method, suggested by Texas Agricultural Experiment Station's Fire Ant Research and Management Program, is widely used. Generally, it involves broadcasting bait formulations over large areas of infestation, followed by an individual mound treatment that comprises dusting, bait placement, drenching or combinations thereof.

Many of the chemical means utilized pose environmental hazards and often times are unsuccessful. Success has been thwarted due to the pheromone response of the ants in the applied mound. Products available in the market today drastically disturb the mound, causing the ants within the colony residing in the mound to emit distress pheromones inducing survival behavior and relocation to another untreated site.

Mechanical destruction of fire ants has been carried out by introducing intense heat, vapor, insecticides, fog and/or steam directly into the fire ant colony. U.S. Pat. No. 4,756,118 to Evans discloses a pressurizing injection gun that delivers a treatment solution comprising active ingredients (pyrethroids) and inert ingredients (petroleum solvents) to the colony. U.S. Pat. No. 5,154,018 to Livingston discloses a method for killing fire ants in subterranean tunnels via fogging with an insecticidal amount of thermal aerosol through a boot covering the subterranean tunnels and then blowing hot air into the subterranean tunnels. Insecticides used comprise at least ˜0.05% by weight pyrethrins (natural or synthetic), or combinations thereof with rotenone, and inert ingredients, including a petroleum base fog oil such as diesel or fuel oil. These processes involved extensive mechanical application of the composition to the mounds and tunnels thereof. Petroleum based solvents are utilized, resulting in large dispersion of the hazardous chemical into the soil, and contamination of air and water.

Various herbicide compositions have been provided for eradicating treatment of plants and seeds. U.S. Patent Application Publication Nos. 2003/0044382, 2003/0068303 and 2006/0116289 to Selvig et al. disclose biologic-chemical herbicide compositions (BCHs) for controlling or preventing weeds and biologic-chemical fungicide compositions (BCHs) that include one or more chemical herbicide/fungicides and microorganism including gram-positive and/or gram-negative bacteria and yeast, disclosing chemical herbicides in manure, wherein the herbicide is appointed to adsorb onto the plants, seeds, and fruits. U.S. Patent Application Publication No. 2005/0065034 to Miele et al. discloses a micro-granular composition with a combined fertilizing and phyto-protective activity, suitable for localization at the moment of sowing and transplanting of crops, and in applications close to the seed; the composition broadly comprises a mineral/inorganic fertilizer, a phyto-protective product, such as insecticides, and a co-adjuvant. These compositions are not appointed to kill fire ants by attacking colonies' mounds. Instead, these compositions are applied to plants. The compositions do not disclose a manure extract mixed with a botanical insecticide and surfactant.

Insecticide fertilizers have been provided for insect and pest control; but many of these are not successful in eradicating IFAs in an environmentally sound manner through interference of the ant pheromone emitting process. U.S. Pat. No. 154,830 to Broaddus discloses a compound consisting of a decoction of horse manure, fennel, mandrake, solution of alum, and coal-oil, with the fennel and mandrake acting as pesticide agents appointed to be applied to pests that injure vegetation. U.S. Pat. No. 5,352,444 to Cox et al. discloses biowaste treatment agents comprising a surfactant component, a metal component, and an aldehyde. Insecticides and rodenticides may be added to keep disease vectors from the biowaste, and include: pyrethroids, pyrethrins, rotenone, sabadillia, ryania, etc. U.S. Pat. No. 5,607,856 to Moon et al. discloses compositions and methods for sterilizing soil comprising contacting soil with an aqueous solution of an activated oxygen species, a divalent cation, a cation redox reducing agent and a water soluble phenolic complex which is extracted from a material selected from the group consisting of humic material, plant material, animal material and manure. U.S. Pat. No. 6,407,038 to Welacky et al. discloses a method for controlling Tylenchid plant-parasitic nematodes through application of an effective amount of an alkaline-stabilized sludge via application to the plant, seed or locus thereof. U.S. Pat. No. 6,699,489 to Driscoll discloses a fire ant pesticide consisting of a liquid derived from a solution of water and animal waste, oil, molasses, and a surfactant used to drown or suffocate the ants when their bodies are thoroughly wetted, once liquid is absorbed into the ground it has no further effect on the fire ants. These compositions do not disclose a manure extract formulated with a botanical insecticide and surfactant; and do not produce an insecticide organic fertilizer that biologically interferes with IFAs pheromone responses.

Botanical insecticides have been utilized to eradicate insects. U.S. Pat. No. 2,151,651 to Christmann et al. discloses insecticidal compositions consisting of naturally occurring insecticides, namely rotenone, combined with a stabilizer selected from a class consisting of aminophenol, dichloroaniline, salicylic acid, and anthranilic acid. Teaching stabilizer materials may be incorporated with the Rotenone by dissolving the Rotenone in a solvent, such as acetone, benzene, or toluene, and adding the stabilizer dissolved in a solvent. U.S. Pat. No. 6,045,816 to Narayanan et al. discloses a clear, one-phase, efficacious aqueous micro-emulsion of an agriculturally active pyrethroid insecticide, consisting essentially of 0.0005-5% of pyrethroid, a N—C₁-C₄ alkyl pyrrolidone, a C₆-C₁₈ alkyl pyrrolidone, an ethoxylated/propoxylated (EO/PO) block copolymer surfactant, an ethoxylated castor oil or a tristyryl phenol ethoxylate, a phosphate ester as pH buffer, and at least 80% of water. U.S. Pat. No. 6,746,988 to Hopkinson et al. discloses an agricultural composition comprising an agriculturally active compound, an alkyl polyglycoside, an anionic surfactant selected from a polyarylphenol polyalkoxyether sulfate and a polyarylphenol polyalkoxyether phosphate, and a basic compound. The agriculturally active compound is a fungicide, an insecticide, an herbicide, a growth regulator, a safener, a plant activator, or a mixture thereof. Insecticides include rotenone or a mixture thereof, among a plentitude of others listed. These compositions have had only varied success in killing IFAs, and act to violently disturb the mound, causing ants to relocate.

Notwithstanding the efforts of prior art workers to construct an efficient composition and method for eradicating insects, and particularly IFAs, there exists a need in the art for an insecticide organic fertilizer composition that eradicates IFAs and biodegrades in the soil, delivering nutritional properties thereto. Also needed in the art is an insecticide organic fertilizer composition that eradicates IFAs, and is environmentally safe even when utilized in large quantities. Further needed in the art is an insecticide organic fertilizer composition that eradicates IFAs, and is formulated in a manner that renders botanical insecticide active ingredients stable in an aqueous organic manure extract. Still further, there is an art recognized need for an insecticide organic fertilizer composition that eradicates IFAs and biologically interferes with IFAs pheromone distress signals, so that the IFAs relocation survival behavior is disrupted and the IFAs remain in the treated mound, facilitating their effective eradication.

### SUMMARY OF THE INVENTION

The present invention provides an insecticide organic fertilizer composition and method for eradicating insects, particularly IFAs. The composition effectively eradicates IFAs, while providing nutrients in the local soil during biodegradation. Generally stated, the composition is composed of a botanical insecticide, preferably rotenone, stabilized in highly refined liquid manure extract. It is environmentally safe, being subject to biodegradation a preselected time following delivery, even when large quantities are applied to soil. A unique formulation renders the botanical insecticide's active ingredients, including rotenone, stable in the aqueous organic manure extract.

Advantageously, the composition biologically interferes with IFAs pheromone distress signals. Upon application of the composition to an IFA mound, the ants therein exhibit a state of sluggishness and gradually begin to die over time. Rather than relocating, as is the nature of IFAs when treated using current compositions and methods, the IFAs continue to reside in the mound. Following application of the composition, sick, weak and dying members of the colony emit hormonal distress, signaling workers to remove them from the colony. Graveyards or “bone piles” form away from the mound as workers remove dead and dying members. This biological response is unique to the composition, and enhances its efficacy for eradicating IFA infestations.

The insecticide organic fertilizer composition comprises acid liquid organic matter derived from animal manure homogenized to yield an organic aqueous environment mixed with an active ingredient, surfactant, solvent, and a fatty acid. Preferably, sulfur is also added to the composition. Active ingredients preferably include botanical insecticides which are subject to degradation after a certain period of time upon delivery to a soil area. The botanical insecticide is a member selected rotenone, pyrethrum, sabadilla (varatrine), neem (azadirachtin), or ryania (ryanodine), or mixtures thereof, with rotenone being preferable for this purpose.

Additionally, a process for formulating an insecticide organic fertilizer composition is provided. Briefly, the first step of the process involves preparation of a refined liquid manure extract by removing a substantial amount of phosphorous from organic matter derived from liquid manure to yield aqueous homogenized low phosphorous manure extract. Next, the aqueous homogenized low phosphorous manure extract is combined with a botanical insecticide and mixed with a surfactant, a solvent, and a fatty acid to form the insecticide organic fertilizer composition. Preferably, sulfur is added to the composition. The botanical insecticide is preferably selected from rotenone, pyrethrum, sabadilla (varatrine), neem (azadirachtin), or ryania (ryanodine), or mixtures thereof; with rotenone being the most preferred.

A method for eradicating Imported Fire Ants utilizing the insecticide organic fertilizer composition is also provided. In practice of the method, an Imported Fire Ant mound infested with fire ants forming a colony is drenched with an insecticide organic fertilizer composition comprising aqueous homogenized manure extract, active ingredient, surfactant, solvent and fatty acid, and preferably sulfur. After application of the insecticide organic fertilizer composition to the mound, the composition begins to take effect, first showing substantial immediate reduction in activity among the colony. Over the course of hours and following days the fire ants become morbid with several fire ants dying. A substantial stop in daily routine among the colony is exhibited. Sick, old, weak and dying fire ants emit a hormonal distress signal, and are removed from the mound. Colony activities shift toward pulling dead and dying fire ants, including queens, eggs, pupae and workers, away from the mound to graveyards or “bone piles”. Swarming queens and males exhibit moribund early-on and gradually begin to die off. This is significant because a mound that is a 1.5 feet in size can produce approximately 25 to 100 swarming queens. These queens are capable of swarming up to 12 miles from the original mound to start new mounds. They live 2-5 years and produce a minimum of 200 eggs a day. Extensive death of the fire ants continues over the following days until the colony is substantially eradicated.

### DETAILED DESCRIPTION OF THE INVENTION

The insecticide organic fertilizer composition, process and method provides an environmentally friendly means of eradicating or controlling the spread of IFAs by using an active ingredient, preferably a botanical insecticide, mixed with homogenized manor and a surfactant. Drenching or spraying mounds of fire ant colonies utilizing the insecticide organic fertilizer composition destroys the pest colony, without adding toxicity to the environment. It has been found that the insecticide organic fertilizer composition masks the pheromone process which otherwise prompts the ants to relocate or run away, so that the ants do not abandon the mound in search of new living quarters. Hence, the ants die without knowing that they are in trouble. Moreover, the composition can effectively be used to kill other insects as well.

Utilization of homogenized manure provides an organic fertilization compound to the soil. It has further been found that the composition renders the botanical insecticide, particularly rotenone, stable in liquid form in the container only biodegrading after a preselected period of time (typically 2 to 5 days) subsequent to pouring the solution onto the soil. Due to rotenone's lack of stability in liquid form, rotenone is typically sold as a powder or dissolved in a heavy, hazardous solvent. Instead, through the insecticide organic fertilizer composition rotenone is dissolved in an organic aqueous environment and remains stable until poured. Consequently, the insecticide organic fertilizer composition nourishes the soil and vegetation while effectively eradicating the IFA colony.

The insecticide organic fertilizer composition includes an active ingredient, preferably being a botanical insecticide, in turn preferably rotenone, mixed with an acid liquid organic matter derived from animal feces homogenized to yield an organic aqueous environment. A surfactant dissolved in an alcohol solvent and mixed with a fatty acid is further combined to formalize the final composition appointed to be applied to an IFA mound. The botanical insecticide is a member selected from the group consisting of rotenone, pyrethrum, sabadilla (varatrine), neem (azadirachtin), or ryania (ryanodine), or mixtures thereof. Rotenone is preferred for this use. Rotenone has a tendency to biodegrade when in solutions, and currently is typically sold as a powder, or is sold dissolved in heavy, hazardous solvents. However, when mixed within the organic aqueous environment of the subject invention, the rotenone remains stable is not subject to degradation while stored in the container. Stability remains for a predetermined period of time (generally _ to _ days) even after the solution is poured onto the IFA nest. After pouring or drenching the nest with the insecticide organic fertilizer composition the botanical insecticide, preferably rotenone, begins to slowly biodegrade, and typically becomes substantially biodegraded after approximately 3 days. The remainder of the ingredients, substantially representing the liquid matter and manure, act to nourish the soil and local vegetation.

The composition of the insecticide organic fertilizer composition uses less solids and more manure liquid, resulting in less sediment. Preferably the active ingredient is a botanical insecticide. The botanical insecticide preferably ranges from about 0.5% to 1% by weight, preferably from about 0.55% to 0.70% by weight, and most preferably from 0.60% to 0.62% by weight. Rotenone is the preferable active ingredient, and is formulated as a liquid flowable with preferably 0.62% of rotenone as an active ingredient (powder and resins). Rotenone is a naturally occurring plant biocide found in roots of Derris plants. The carrier used to support the rotenone active ingredient is a refined, and well-stabilized liquid manure extract having high property and content of readily available plant and grass nutrients ranging from the macro to the micro nutrient spectrum.

Preferably, the surfactant utilized is a nonionic surfactant, i.e. alkyl poly(ethylene oxide), copolymers of poly(ethylene oxide) and poly(propylene oxide), and alkyl polyglucosides. Nonionic surfactant, such as tergitol, Triton X-100, or Brij 97, preferably ranges from about 7% to 10% by weight, preferably from about 7.5% to 9.5% by weight, and most preferably from about 8% to 9% by weight. Solvent, preferably an alcohol, such as butanol, ranges from about 1.5% to 3.5%, preferably from about 2% to 3% and most preferably from about 2.25% to 2.5%. Fatty acid, such as oleic acid, ranges from about 0.5% to 2%, preferably from about 0.75% to 1.5% and most preferably from about 0.9% to 1.0%. The remainder of the solution is liquid manure present as a diluent up to 100% and comprising liquid organic matter derived from animal feces, such as cattle, or other domestic animals.

Liquid manure from dairies is preferably utilized due to the consistency of the substance. The manure is filtered to remove solid material. Other domesticated animal or livestock manures can be utilized, but cattle manure is the most preferable. A “waste reduction” process is utilized in manufacturing manure extract, including reduction at free-stall dairies where a substantial amount of phosphorous contained in the liquid extracted from the manure is removed. Removal of substantial amounts of phosphorous is significant because phosphorous in dairy waste seeps into the local water tables (watersheds) near dairies, causing ground contamination. Through the waste reduction process, approximately 1,000 ppm out of approximately 1,100 ppm of phosphorous is removed from the manure extract. The aqueous liquid manure represents roughly 75% to 85% by weight of the insecticide organic fertilizer composition.

Preferably, the insecticide organic fertilizer composition also includes sulfur, present in the following amounts: (i) preferably in an amount ranging from 1%-10% by weight; (ii) more preferably in an amount ranging from (+/−5%) 3.325% to 3.675% by weight; and (iii) most preferably in an amount of 3.5% by weight.

The insecticide organic fertilizer composition acts as an insecticide and fertilizer. It is applied as a drench after mixing the concentrate with water and drenched on the mound. Immediately upon application the first observation is an obvious activity reduction of the ants, as the ants become less aggressive, sluggish and slow. Over passing hours and subsequent days, dead ants are noticed and surviving, yet moribund ants stop daily routine including: foraging for food, rebuilding caved mounds and clearing obstructed tunnels. All activities shift toward removing the dead and dying members, including queens, eggs, pupae and other workers away from the mound to graveyards called “bone piles”. Swarming queens and males exhibit moribund early-on and gradually begin to die off. This is significant because a mound that is a 1.5 feet in size can produce approximately 25 to 100 swarming queens. Each of these queens is capable of swarming up to 12 miles from the original mound to start a new mound. Swarming queens live 2-5 years and producing a minimum of 200 eggs a day.

In a social ant mound setting, sick, old, weak and dying members emit hormonal distress that signal workers to remove them from the colony to avoid potential spread of the unhealthy spell. Such process, scientifically called necrophoresis (removal of dead bodies), is one of the insecticide organic fertilizer compositions unique features, resulting from breakthrough biotechnology embodied by the formulation. Products available today's market drastically kill or violently disturb the mound, inducing emission of hormones. These hormones tend to trigger survival behavior by signaling relocation to another untreated site. The bone pile, a naturally occurring practice among social organisms (cemetery for human) is annihilated by these conventional products—a factor that significantly limits their efficacy. By way of contrast to conventional insecticides, the insecticide organic fertilizer composition of the present invention triggers a new mode of action that may best be described as “mound auto destruction”. This mound auto destruction is created by the removal of virtually all ants that come into contact with the insecticide organic fertilizer composition.

Tests have been carried out utilizing an insecticide organic fertilizer composition that comprises rotenone, 0.62% by weight, as the active ingredient, nonionic surfactant being tergitol, oleic acid, alcohol solvent and liquid manure extract. Three areas in the states of Texas, Arkansas and Oklahoma were studied. One treatment of the insecticide organic fertilizer composition was replicated four times per site with four 15 m radius circular plots considered as replicates. A total of 676 mounds were tested, with 540 mounds being treated with the insecticide organic fertilizer composition and 136 mounds acting as controls treated with plain water. The study was carried out over 32-days, during which time all 676 mounds were excavated; mound activity and mortality were recorded; and results from treated plots were compared with the control plots at each site. Satellite mounds, if any, were also noted, to account for any ant relocation and/or movement. Control achieved in the mounds was rated 100% or complete when no brood (eggs, larvae, pupae) and alates (winged adults) were present and less than 25 ants were observed within 5 seconds after the initial disturbance during the excavation process. A 0-5 scale was utilized to visually rate mound activity. A 0 rating indicated no control and 5 rating indicated full control. Activity was additionally based on the presence of brood (immature), alates or if more than 25 ants were counted within 5 seconds after the initial disturbance during the excavation process. For final evaluation, the percent control was calculated as follows: 100×(Number of dead mounds post-treatment)/(Total number of mounds pre-treatment).

TABLE I
Activity Preceding Treatment By
The Insecticide Organic Fertilizer Composition
Mound Activity Measured At Each Test Site

| Repilcation | Location 1 | Location 2 | Location 3 | Mean Replicate |
|---|---|---|---|---|
| 1 | 4.30 | 4.50 | 4.90 | 4.57 |
| 2 | 4.50 | 4.40 | 4.90 | 4.60 |
| 3 | 4.50 | 4.60 | 4.80 | 4.63 |
| Control | 4.70 | 4.40 | 4.80 | 4.63 |

TABLE II
Activity Post-treatment Of
The Insecticide Organic Fertilizer Composition
Mound Activity Measured At Each Site

| | Site | | | | | | | |
|---|---|---|---|---|---|---|---|---|
| | Location 1 | Location 1 | Location 1 | Location 2 | Location 2 | Location 3 | Location 3 | Location 3 |
| Date | DAT = 3 | DAT = 11 | DAT = 18 | DAT = 10 | DAT = 17 | DAT = 3 | DAT = 10 | DAT = 17 |
| Rep/Plot | | | | | | | | |
| Mean R1 | 1.50 | 0.90 | 0.10 | 0.60 | 0.20 | 1.50 | 0.30 | 0.30 |
| Mean R2 | 1.70 | 0.30 | 0.10 | 0.50 | 0.00 | 0.90 | 0.40 | 0.40 |
| Mean R3 | 2.30 | 0.40 | 0.00 | 0.60 | 0.00 | 1.00 | 0.00 | 0.20 |
| Mean | 4.50 | 4.50 | 4.90 | 4.30 | 4.30 | 4.80 | 4.80 | 4.80 |
| Control | | | | | | | | |

Overall pre-treatment activity at all sites considered produced a 4.63 rating (Table I). A general trend of post-treatment mound activity indicated reduced activity at all sites (Table II) with ant activity visibly reduced within 15 minutes to one hour after the drench treatment. Untreated plots were active throughout the monitoring period (4.90, 4.30, and 4.80 at last monitoring dates of DAT=18, 17 and 17 for Locations 1, 2, and 3 respectively). The post-treatment mound activity rating ranged from 5 to 0; this indicated a marked reduction due to ant mortality.

The mortality of colonies in the mounds constituted the main parameter used to evaluate efficacy of the insecticide organic fertilizer composition's on IFA control. Ant mortality (workers, exposed broad and reproductive) was noted within one hour post-treatment. Three days after the treatment several dead mounds were noticed in treated plots. There was a significant necrophoresis (removal of dead ants by workers) following the treatment, resulting in dead ant piles on top or around the mound.

Each site had the same trend of mortality and ant pile formation Conversely, control (untreated) plots showed little or no ant mortality or dead ant piles on top or around the mound, with any mortality attributed to variables such as natural death, dry weather, livestock trampling.

Having thus described the invention in rather full detail, it will be understood that such detail need not be strictly adhered to, but that additional changes and modifications may suggest themselves to one skilled in the art, all falling within the scope of the invention as defined by the subjoined claims.

What is claimed is:

1. An insecticide organic fertilizer composition, comprising:
a. acid liquid organic matter derived from animal manure homogenized to yield an organic aqueous environment;
b. an active ingredient;
c. a surfactant;
d. a solvent; and
e. a fatty acid.

2. An insecticide organic fertilizer composition as recited by claim 1, wherein said active ingredient is a botanical insecticide subject to biodegradation after a preselected period of time following delivery to a soil area.

3. An insecticide organic fertilizer composition as recited by claim 2, wherein said botanical insecticide is selected from the group consisting of rotenone, pyrethrum, sabadilla (varatrine), neem (azadirachtin), ryania (ryanodine), and mixtures thereof.

4. An insecticide organic fertilizer composition as recited by claim 3, wherein said botanical insecticide comprises rotenone.

5. An insecticide organic fertilizer composition as recited by claim 1, wherein said botanical insecticide ranges from 0.5% to 1% by weight.

6. An insecticide organic fertilizer composition as recited by claim 5, wherein said botanical insecticide ranges from 0.60% to 0.62% by weight.

7. An insecticide organic fertilizer composition as recited by claim 1, wherein said surfactant is a nonionic surfactant.

8. An insecticide organic fertilizer composition as recited by claim 1, wherein said surfactant ranges from 7% to 10% by weight.

9. An insecticide organic fertilizer composition as recited by claim 8, wherein said surfactant ranges from 8% to 9% by weight.

10. An insecticide organic fertilizer composition as recited by claim 1, wherein said solvent is an alcohol.

11. An insecticide organic fertilizer composition as recited by claim 1, wherein said solvent ranges from 1.5% to 3.5% by weight.

12. An insecticide organic fertilizer composition as recited by claim 1, wherein said fatty acid is oleic acid.

13. An insecticide organic fertilizer composition as recited by claim 1, wherein said fatty acid ranges from 0.5% to 2% by weight.

14. An insecticide organic fertilizer composition as recited by claim 1 comprising sulfur.

15. An insecticide organic fertilizer composition as recited by claim 14, wherein said sulfur ranges from 1% to 10% by weight.

16. An insecticide organic fertilizer composition as recited by claim 15, wherein said sulfur ranges from 3.3% to 3.7% by weight.

17. A process for formulating an insecticide organic fertilizer composition, comprising the steps of:
a. removing a substantial amount of phosphorous from organic matter derived from liquid manure to yield aqueous homogenized low phosphorous manure extract.
b. combining said aqueous homogenized low phosphorous manure extract with a botanical insecticide, said botanical insecticide being subject to biodegradation after a certain period of time upon delivery to a soil area; and
c. mixing said aqueous homogenized low phosphorous manure extract and said botanical insecticide with a surfactant, solvent, and a fatty acid to form said insecticide organic fertilizer composition.

18. An insecticide organic fertilizer composition process as recited by claim 17, wherein said botanical insecticide is selected from the group consisting of rotenone, pyrethrum, sabadilla (varatrine), neem (azadirachtin), ryania (ryanodine), and mixtures thereof.

19. An insecticide organic fertilizer composition process as recited by claim 17, comprising the step of adding sulfur.

20. A method for eradicating Imported Fire Ants comprising the steps of:
a. drenching an Imported Fire Ant mound infested with fire ants forming a colony with an insecticide organic fertilizer composition comprising an aqueous homogenized manure extract, an active ingredient, a surfactant, a solvent and a fatty acid; and
b. waiting for a preselected period of time until said insecticide organic fertilizer composition takes effect, said composition having an affect on said mound that comprises:
i. substantial immediate reduction in activity among said colony;
ii. over passage of time, measured in hours and subsequent days, said fire ants becoming moribund with several fire ants dying;
iii. a substantial stop in daily routine among said colony as sick, old, weak and dying fire ants emit hormonal distress signals and are removed from the mound;
iv. a shift in colony activity toward pulling dead and dying fire ants, including queens, eggs, pupae and workers, away from said mound to graveyards; and
v. extensive death of said fire ants, continuing throughout said subsequent days, until said colony is substantially eradicated.

21. A method for eradicating Imported Fire Ants as recited by claim 20, wherein said active ingredient is a botanical insecticide.

22. A method for eradicating Imported Fire Ants as recited by claim 20, wherein said botanical insecticide is selected from the group consisting of rotenone, pyrethrum, sabadilla (varatrine), neem (azadirachtin), ryania (ryanodine), and mixtures thereof.

23. A method for eradicating Imported Fire Ants as recited by claim 22, wherein said botanical insecticide comprises rotenone.

24. A method for eradicating Imported Fire Ants as recited by claim 20, wherein said insecticide organic fertilizer composition further comprises sulfur.

25. A method for eradicating Imported Fire Ants as recited by claim 20, wherein said biotanical insecticide is environmentally safe.

26. A method for eradicating Imported Fire Ants as recited by claim 20, wherein said biotanical insecticide additionally functions as a fertilizer that nourishes soil near said mound.
